(19) United States
(12) Patent Application Publication
(10) Pub. No.: US 2007/0040699 A1
(43) Pub. Date: Feb. 22, 2007

(54) Asynchronous physical exchange system

(76) Inventor: Inshan Ali Khairullah, Jamaica Hills, NY (US)

Correspondence Address: F. CHAU & ASSOCIATES, LLC, 130 WOODBURY ROAD, WOODBURY, NY, 11797, US

(21) Appl. No.: 11/450,200

(22) Filed: Jun. 9, 2006

Related U.S. Application Data
(60) Provisional application No. 60/688,940, filed on Jun. 9, 2005.

(51) Int. Cl. G08B 5/22

(52) U.S. Cl. 340/825.36

(57) ABSTRACT

A network-based goods exchange system includes a mailer for receiving data from a first party and transmitting the data to a second party, wherein if the data received by the second party is confirmed, the mailer sends the first party a unique identifier and the second party a unique identifier; a database for recording activity of the mailer; a storage unit including a lock for securing an entrance to the storage unit, wherein the entrance to the storage unit is opened in response to the unique identifier sent to the first party, wherein when the entrance is opened the first party places a good inside the unit and closes the entrance, wherein when the entrance is closed the first party no longer has access to the storage unit; and a server for receiving an indication that the first party has accessed the storage unit, wherein the server initiates a reminder that is sent to the second party, wherein after receiving the reminder, the second party opens the entrance, retrieves the good and closes the entrance, wherein when the entrance is closed the second party no longer has access to the storage unit.

### CROSS-REFERENCE TO RELATED APPLICATION

This application claims the benefit of U.S. Provisional Application No. 60/688,940, filed Jun. 9, 2005, a copy of which is herein incorporated by reference.

### BACKGROUND OF THE INVENTION

1. Technical Field

The present invention relates to a system for exchanging goods, and more particularly, to a network-based goods exchange system.

2. Discussion of the Related Art

In the not so distant past, trade occurred when two people coincided time and place to exchange goods. Despite recent innovations such as PayPal, EBay, e-check, and e-ticket, if a person wants to send a physical object to another person they have to use a third party such as the United States Postal Service, Federal Express, DHL or UPS, the two parties have to meet, or they have to find another way to send/receive the object.

### SUMMARY OF THE INVENTION

In one embodiment of the present invention, a network-based goods exchange system comprises: a mailer for receiving data from a first party and transmitting the data to a second party, wherein if the data received by the second party is confirmed, the mailer sends the first party a unique identifier and the second party a unique identifier; a database for recording activity of the mailer; a storage unit including a lock for securing an entrance to the storage unit, wherein the entrance to the storage unit is opened in response to the unique identifier sent to the first party, wherein when the entrance is opened the first party places a good inside the unit and closes the entrance, wherein when the entrance is closed the first party no longer has access to the storage unit; and a server for receiving an indication that the first party has accessed the storage unit, wherein the server initiates a reminder that is sent to the second party, wherein after receiving the reminder, the second party opens the entrance, retrieves the good and closes the entrance, wherein when the entrance is closed the second party no longer has access to the storage unit.

The foregoing features are of representative embodiments and are presented to assist in understanding the invention. It should be understood that they are not intended to be considered limitations on the invention as defined by the claims, or limitations on equivalents to the claims. Therefore, this summary of features should not be considered dispositive in determining equivalents. Additional features of the invention will become apparent in the following description, from the drawings and from the claims.

### BRIEF DESCRIPTION OF THE DRAWINGS

FIG. 1 is a relational diagram of an asynchronous physical exchange system according to an exemplary embodiment of the present invention;

FIG. 2 is a workflow of a web interface according to an exemplary embodiment of the present invention; and

FIG. 3 is a class overview diagram of an asynchronous physical exchange system according to an exemplary embodiment of the present invention.

### DETAILED DESCRIPTION OF EXEMPLARY EMBODIMENTS

An asynchronous physical exchange system (hereinafter referred to interchangeably as the “E-Lock” system or just the “system”) according to an embodiment of the present invention is used to transfer physical objects from one person to another with the use of network technology and security.

With the E-Lock system, at its basic form, there are no human intermediaries and there are no time delays specified by a third group or party. This means that the system can be as asynchronous or as synchronous as the parties involved allow. In other words, the space and time is controlled or agreed upon by the sender, receiver, and no one else.

The E-Lock system may include several modules.

The main module is a modified safe, box or locker whose lock is electronically controlled. Using Internet and networking technology, the lock is connected to a computer program that monitors access to the box. A mailer module is a web interface that allows users to initiate a transaction, handles confirmations, and processes email. An E-Server module communicates with the safe, verifies a user and controls flow of the transaction by accessing a database to confirm and update information. This program can only be accessed by the safe and is transparent and inaccessible to any user. A database module stores information such as sender id, receiver id, pin codes, and status of any particular transaction. The main module is electronically controlled and can only be opened or closed by the E-Server. The main module has a keypad and a card swipe, similar to that of an ATM machine to ensure verification of the user.

The E-Lock system requires two people: one to receive a physical object and one to send the object. In the following example, Joe (sender) wants to give Jane (receiver) a pair of headphones.

Here, it will be assumed that Joe and Jane know each other, have each other's email address, or that they are registered members of an E-Lock service that includes their id and email info stored in a database for automated use. Joe has a pair of headphones that he wants to give to Jane. Instead of directly emailing her and playing email tag to synchronize a time and place to meet up, Joe will go to the Mailer interface via Internet. He will fill out a form with the following information: Jane's email address, a brief description of the object, and the time he plans to deposit the object into the box (e.g., 4:00 PM on Tuesday). Joe presses “send”. Jane will receive an email from the Mailer, indicating that Joe has headphones for her and that it will be available by 4:00 PM on Tuesday. Jane will either confirm or deny the transaction. If she denies, Joe will be sent a rejection email and the transaction continues no further.

However, if she confirms, the Mailer program will email Joe and Jane unique pin codes. The E-Lock box will then be on in a “standby mode” waiting for the sender to use the box. Joe will swipe his card and enter the pin code that was emailed to him. The lock will open and he will have access to the box. After Joe deposits the item in the box, he locks the box. At this point, the only person who can access the box will be Jane. Joe no longer has access. When the Joe closes the box, a reminder email will be sent to Jane, alert her that she can receive the object. As with Joe, Jane will go to the box, swipe and enter pin code and get the headphones. An email is sent to Joe, confirming the transaction and the E-Lock box is reset.

It is to be understood that the E-Lock box can be expanded to accommodate various exchange models. For example, it can be connected to a money receiving/counting machine for selling purposes. Sine the E-Lock box only requires two people; it can be displayed in a Post Office or a pickup location (P.O. Box), an office, or corporate building.

Some principles of the E-Lock system include modularity—such that changes in components should not affect the entire system. Each function can be modulated as much as possible so that it may be replaced or improved upon with minimal disturbance to other components; security—any changes to the system or improvement require the general security to be re-evaluated and always improving. No component should lower the security level of the system in general or otherwise; and ease of use—the system should be able to be used with a minimal amount of steps or instructions.

Exemplary requirements of the E-Lock box on the hardware side are that: it should have a cubicle shape/size, be solidly constructed using wood, Plexiglas, or metal; include a keypad for pin code entry, a card swipe/barcode scanner; and an electronically controlled locking mechanism. On the software side, the system should include a Java program, using sockets; access to the database server; front end for user registration and sign-on access; should be able to email clients; security across the network; and stability and ease of initiation and restarting.

The system is as modular or object-oriented as possible. This means that the basic functions and requirements were answered at a high-level encapsulation and the details are answered within the components of that encapsulation.

As previously mentioned, the system consists of a web-interface called the Mailer. This program is the front end or reception desk of the E-Lock box, whose job is to allow users to initiate a transaction. The main part of the system is a modified safe, or box, whose lock is electronically controlled. Using Internet and networking technology, the lock is connected to the specific program that monitors access to that box, called the E-Server. This program verifies user and controls the flow of the transaction by accessing a Database to confirm and verify information. This program should only be accessed by the E-Lock safe, is invisible, and is completely inaccessible to any user.

A more detailed description of the system follows.

The Mailer interfaces with users. It reserves slots and sends info to be logged into a database. This program is essentially the front end or reception desk of the E-Lock System, whose job is to allow users to initiate and confirm transactions, generate pin codes, and send email to the users.

The E-Server is transparent and inaccessible to users. It communicates with the E-Lock and controls the sequence of a transaction. It also looks up and updates the same database as the Mailer.

The Database stores information such as sender info, receiver info, pin codes, and status of any particular transaction. It also contains a list of registered users. Only registered users should use the E-Lock box.

E-Lock box contains an electronically controlled safe, or locker, that should only be opened or closed by the E-Server Program. The E-Lock box's duties include user interfacing, protection of the item, network communication to the E-Server, and control of the locking mechanism.

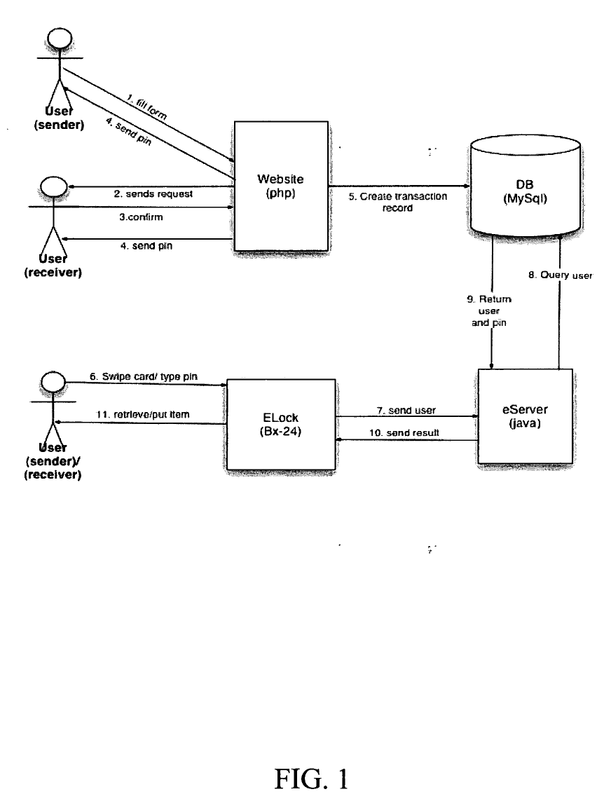

A relational diagram of how the systems works is illustrated in FIG. 1 and will now be described.

The E-Lock module consists of several components: Microprocessor, Lock, CardSwipe, Keypad, Display, and Network. The hardware and software implementations of each component are described below.

Microprocessor:

For the hardware technology, a BX-24 microprocessor was used. A PIC Series microchip may also be used, which is much cheaper but also requires lower level programming. Ideally, the Lockbox would contain a keypad, and card reader, lock control, and some kind of report to the user. The BX-24 easily accommodates concurrency or modules that may be implemented. The BX-24 is a mid-level microprocessor. It requires no special initialization or wiring except for a serial connection to a compiler on a PC. It has 21 input/output pins, and 400 bytes of RAM.

CoBox Micro/XPort

As mentioned before, the processor should be able to communicate with the E-Lock program. This requires a device to convert serial to TCP packets (e.g., Serial-to-Ethernet). These devices are called embedded device servers. One such device that handles this is CoboxMicro. However, the CoboxMicro does not support the AES encryption. For this, an XPort SE can be used. This device is a smaller version of the CoBox and very similar in setup and usage.

Keypad:

For pin code input, an inexpensive 12-digit (4 rows×3 columns) keypad was used. This is the standard keypad seen on telephones and ATM machines. This was chosen because of its familiarity, and addresses the objective of ease of use. The Keypad is matrix encoded, meaning that there are 3 column pins and 4 row pins (hence 4×3), and requires only 7 pins to operate, as compared to 12 pins for a non-matrix keypad (1 pin per button). Using the encoded keypad requires a row-column scanning algorithm to be implemented in the BX-24 code. This is discussed hereinafter in detail with regard to the Keypad module.

Card Reader:

A magnetic stripe card reader was used. Again, ease of use is being addressed as many are familiar with ATM machines or swipe stations. The product used was the Magteck #21040025. This product contains an RJ-11 (standard telephone jack). It contains six wires, one is a chassis ground and the rest are as follows: Red—+5 VCC; Black—Common ground or VSS; Green—Clock; Brown—Data; White—Read enable.

When a card is swiped, the White goes low and the data from the card is read and latched onto the rise of the white line current after the card swipe. An easy analogy is to imagine the white line as a desk drawer. While the drawer is open (white line LOW) the data are placed in the drawer until it closes (white line HIGH). Synchronization occurs using a clock (green line).

Locking Mechanism:

A deadbolt connected to a servo was implemented as the locking mechanism. The deadbolt provides simple but effective security and the servo latch makes it electronically-controlled.

Display:

For the display, an LCD screen with a small footprint such as the Seetron-BPI216 was used. It is an LCD device that uses the serial (RS-232) protocol to display messages. It will only require one wire to be connected to the microprocessor (BX-24). The BX-24 can send a serial string “Hello” to the device and it will be displayed exactly as received.

Enclosure

A material that is relatively inexpensive but still sturdy enough to relay the message of security such as Plexiglas or high quality (e.g., ¾″ thick) plywood could be used.

The E-Lock addresses the following functions, in order: 1) user input of swipe card information and transmit this data across the net; 2) user input of pin code from keypad and transmit this data across the net; 3) receive from the net an authentication status of both pin and swipe card; 4) process and executes response according to user input and authentication status; 5) control lock mechanism (opening and closing).

With the BX-24 these steps have been modulated. They are described below.

KeyPad:

Call the keypad function that reads the numbers pressed. The retrieve numbers are stored in an array. The “*” on the keypad is a carriage return. Pressing this button after a sequence of numbers, the logic will check if the sequence (stored in an array) is of proper size (4 numbers or 9 numbers). The logic will then send the sequence through the network if properly formatted. The Keypad module processes one number at a time. This means that the logic actually stores each individual number every time the Keypad function is successfully called.

Here is the pseudocode:

from keypadmain:

loop until “#” is pressed

number=keypadfunction( )

add number to sequence

end loop

check to see if the sequence has the correct number of digits,

if so, then send it over the network and exit to main,

else, go back into previous the loop,

Card Swipe:

Here, a program written for a PIC chip that reads the card and even has error correction was used. Instead of porting the code to basicx (language for the BX-24), a PIC chip was used as a slave processor to read the card and send the number to the master BX-24. A serial connection lies between the two chips. Thus, the PIC 18F252 chip is interfaced with the magnetic card read and reads the number being swiped. If the card is a valid card, the information is sent through a serial port connection to the BX-24. The BX-24 ensures that the card is a valid card (determined by unique characters sequencing). The number sequence is nine digits long. The logic will verify sequence and will then send the sequence through the network if properly formatted for authentication.

Here is the pseudocode:

from cardswipe function:

tell the slave PIC that we are ready to receive.,

wait for incoming data,

check if data is from a valid card,

if so, send to network and exit to main function,

else, do it over again and tell,

slave PIC:
wait for bx-24 to be ready to receive,
initializing looping sequence and wait for card to be introduced,
if card is being swiped, read incoming data from card reader,
error check to make sure the read was successful,
if successful, then send to the BX-24,
else, discard values and go back to initializing loop,
after being sent, wait for the BX-24 again,

Locking Mechanism:

If everything works and the user has a valid card and has entered the correct pin, the logic will call the locking module. Its sole responsibility is to open or close the physical locking mechanism. When called upon, the module opens the lock and goes into a standby loop until the user presses the “*”, which means he/she has finished removing or placing the item. When the user presses the “*” button, the module re-engages the lock and returns to main.

Here is the pseudo-code:

from main program,
locking function,
   open the lock,
   loop,
   if user presses “*” then break out of loop,
   done,
   close the lock.

return to main program

Network:

After a successful checking of array size from the card swipe, the logic will send information via CoBox or XPort. This is very easy to implement using the BX-24. First, when the program first starts, a com port is opened and the I/O is assigned to designated pins. These pins are wired to the CoBox or XPort. When a number or any information needs to be sent, the BX-24 will place the data in a buffer that is mapped to the output pin. The CoBox constantly reads info from the pin (it considers it as input (incoming from BX-24)) and sends it to the E-Server program across the net.

Here is the pseudocode:

from main program or its modules,

send function (when called),
place number in buffer,

exit out of function

from cobox: (hardware implemented)

reads input pin with respect to bx-24 and sends it through network,
place in input buffer,
loop again

After each send, the logic will wait to receive incoming data from the network. This data are the following, status of transaction, approval of lock.

Receive function. There is separate module for the receive function. Also, receive is the inverse of send function.

Here is the pseudocode:

from main program or its modules,

receive function (when called),

check if a value is in buffer. if so, retrieve data, store in an array,
return to calling function or main program,

process the array and data and take action according to protocol

Protocol:

There are quite a few messages being sent from module to main, to the display, and to and from the network. For this reason, a protocol of messages was created. This is also implemented for expandability and future use. If one wants to include another module, by using the protocol, the communication between the added module and existing ones would be easier to implement. Sending whole strings across the net is a major risk as compared to sending codes. Using a protocol centralizes and standardizes messages so that components can be tested individually. For example, to test if sending an open lock code will actually open the box, the code is sent to the box via terminal program without using the server or Database programs. This is a good asset for debugging and development. This protocol can be revised to accommodate different variations of the system.

There two types of messages: box to server—messages sent from box to server; and server to box—messages sent from server to box. Only two messages are to be sent from the box to server, they include: the pin data and the card swipe data. They may also include an optional status data message. The following protocol may be used:

Byte 0=size of the incoming

Byte 1-byte15=data

This way, the server program reads the first byte to see bow many bytes to retrieve and processes it (see e.g., the server code).

Here is the mapping of the message protocol:

Byte 0=origin type

Byte 1-4=details

Byte 0—1 from box
2 from server

Byte 1 1—approval or okay
2—denial
3—instruction

byte 2 1—user
2—pin
3—press *
4—shutdown
5—keypad

byte 3 (optional) 1—access
2—exist
3—no user

byte 4 can be optional at this point. Usually set to zero.

Using this protocol if the user keys a pin of “1234” the box will send: 41234. If a card is swiped as “567848321”: the data sent from the box will be: 9567848321. If the box receives and code of: 2 2 1 2, it can be read as “approval of user”, or if: 2 2 2 3 is received, it can be read as “no user selected”.

Other modules for the system and associated software will now be described.

Mailer

As mentioned earlier, the Mailer is the web interface that allows initiation of a transaction and handles confirmations and emails. The Mailer was created using PHP, and generates html code dynamically; however, it may be implemented in various programming languages as well. When the user first visits the Mailer site (e.g., mailer.php), he must enter the correct login information (username, password). A successful login loads a form and asks for the intended recipient user name. For this example, it is assumed that the user knows the username of the other registered users. Afterward, an email is sent to the intended receiver. The receiver confirms by clicking onto a link leading to “confirm.php” page. After which, two unique 6-digit pin codes are randomly generated and sent through email to the sender and receiver and a transaction record is stored in the database.

Database

The database was designed with modulation in mind. It is on the MYSQL platform, which is a database language. Multiple tables such as user list, and a transaction buffer were used for ease of development and extension and for database management.

The database consists of five tables: Userlocks—this is a table of login information and personal info about each user. Such information are, id number, email address, name. Translock—which is essentially a buffer for user login and registration. It stores information about registration and approval. It stores information accordingly. KeyLocks—is a main table that contains, transactions and their respective progress. This also includes the sender and receiver reference pointers and their respective pin numbers. Elocks—is the only table accessed by the E-Server and provides an interface to eServer from the cluster. It stores current information or progress of a particular transaction. This includes ID, pin of the next/current person. When that person finishes their part of the transaction, Elocks will update to accommodate the next user or next transaction.

When the user logs in and enters the correct information, a transaction record and transaction ID are generated. This is a unique identifier mapped to the particular transaction. This record is stored in the translock table. This table acts as a “buffer,” wditing for confirmation from the receiver. Upon confirmation from the receiver (confirm.php) page, the transaction record is moved to the keylocks. This is where the record is monitored and updated throughout the transaction. If the E-Lock is not in use, the sender id number and pin information is sent from the keylock record to the elock table. The E-Server program will read this information according to the user interaction upon the box. After a transaction is complete (e.g., the receiver removes the object and re-locks the box), the E-Server will attempt to load the next transaction record from the keylocks table (if there are any more transactions to execute). If there are no transactions to queue, then elocks is put to sleep (e.g., in use=0) and can be awakened by another confirmation.

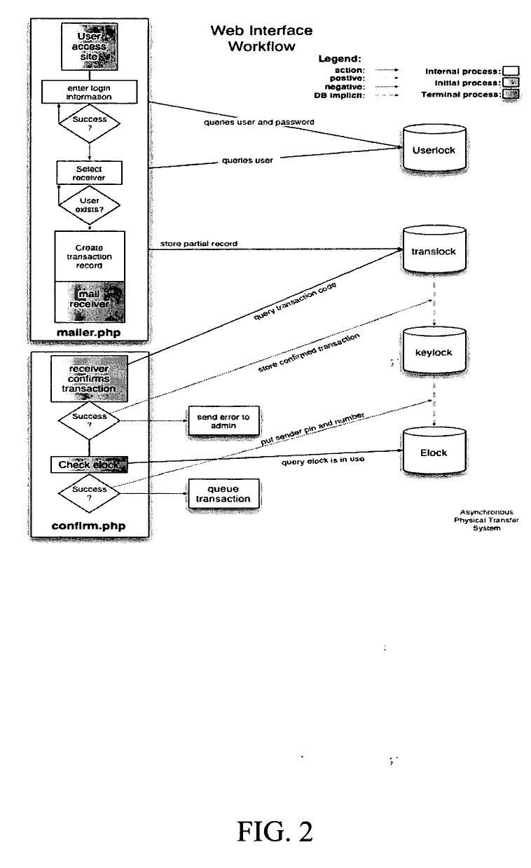

A web interface workflow is illustrated in FIG. 2.

E-Server:

The E-Server was written in Java 1.4. It contains a MySQL connection library to support a connection to the database. This program creates a Java thread object that creates a socket connection to the E-Lock. After a connection is established, the program waits for incoming bytes from the E-Lock through the network. To ensure synchronization, the first byte is read and should contain a value that is the number of bytes that E-Server should read. After reading all the bytes that are stored in a byte array it will determine its validity and will process the incoming string according to its size. If the byte array size is, for example, 9, then the E-Server has just received a user id number and will begin a Database connection.

To handle the DB connection, another class is created also called E-Lock. This class is separate form the E-Lock physical module (e.g., the E-Lock box). This E-Lock Java class is an interface so the E-Server can communicate to the Database. After E-Lock establishes a connection to the Database, the E-Server will convert the byte array into a string, and gives it to E-Lock. The E-Lock will generate a query string (MySQL in this case) and send the query to the Database. If it is successful, the Database will respond by giving it the pin code and will send the pin code back to E-Server. When this code is received, the E-Server will consider the user id valid and send a valid signal across the net to E-Lock. Afterwards, and when E-Lock sends the correct pin code, E-Server will verify it without connecting to the DB again as the pin code was previously obtained from the successful query. The E-Server will compare the pins. If the pins match, the E-Server sends the commands to the E-Lock to “open the lock”.

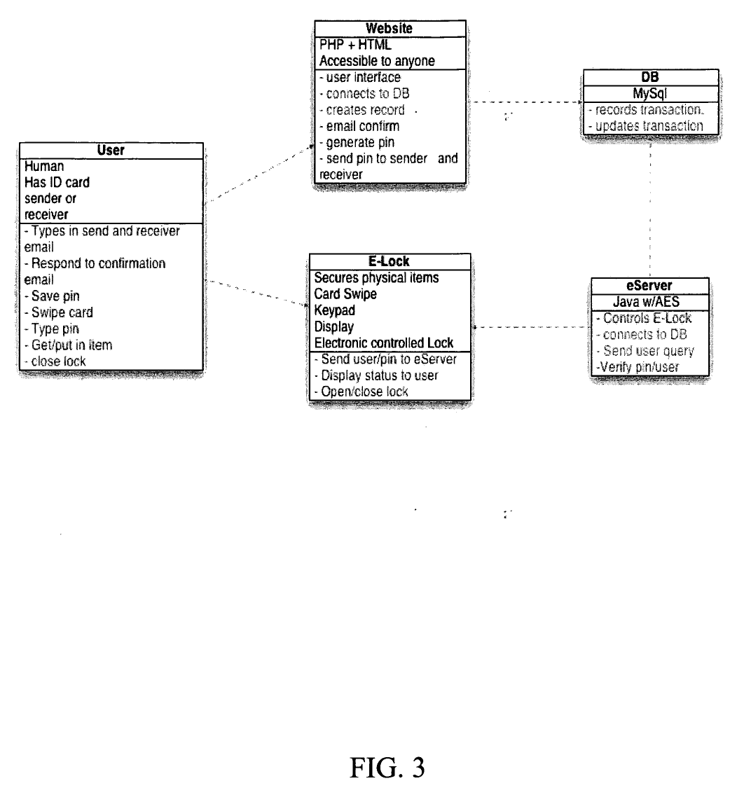

A class overview of the system is shown in FIG. 3.

Security:

The integration of network security and protocols is an important part of the system. There are two main aspects of security in this system will now be discussed.

Hardware:

For more security, the E-Lock box could be made of a vault-like material such as steel or admantium. Its locking mechanism could be a magnetic lock that is more secure than a typical suitcase lock. An armored cable could also be used to prevent forceful entry.

Security Protocol:

Includes and impersonation prevention and network security.

Impersonation:

User Authentication can be compromised through impersonation. In the same style of ATM transaction, this system uses a two-factor authentication requiring the verification of: “something you have”, and “something you know”. The card reader module reads only certain ID cards. To overcome this, the impersonator must steal a valid card, or forge one. The latter of which is quite difficult since the pin code is sent to the registered user email address. This email address is password protected. For impersonation to work, the card, or forgery thereof, and access to the user's email account must be obtained.

Network Security:

Since a weakness may exist in the communication lines of the system between its modules, the communication lines should be secured. This is accomplished by encrypting data before it is sent across the network. The two major lines to be secured are: the E-Lock to E-Server and the User to Web Interface.

Another way an intruder can gain access to information is through “packet sniffing”. This is where network information is visible to the intruder and he tries to determine what packet of information is important. However, using encryption, this kind of attack is severely hindered as the information in the network conduit is encrypted and illegible. Encryption is the method of placing plain text into an encoded cipher text. The cipher text is transmitted through the network and is decrypted by the recipient. In transit, however, the cipher text is theoretically illegible. In reality an intruder can use a “simple” or a “chosen” plain text attacks to determine the plain-cipher relationship. To combat this, the most contemporary cryptography suite that can be supported by Java and the embedded device server of the ELock was used.

Java was used since once its source code is compiled it cannot be changed to be deciphered, except with reverse engineering. The Java Software Development Kit (SDK) 1.5 includes the JCE, or Java Cryptographic extension, which allows developers to implement a multitude of encryption suites such as AES, DES, and MD5. It is to be understood that the most contemporary form of encryption and data security that can be used in the communication lines of the system. Since the Java program is the “middle man” the security/encryption scheme should be utilized by Java.

The cryptographic suite used is Advanced Encryption Standard (AES) based of the Rijndael algorithm, created by Joan Daemen and Vincent Rijmen. It is supported by both Java and XPORT-SE. AES is a symmetric cipher, meaning that both parties have identical private keys, to decrypt and encrypt information. For example, both the E-Lock and E-Server can have an arbitrary passkey like “Rubber duckies.” This passkey is hardcoded into their respective programming. Any change to the passkey will require explicit access to the embedded device server (E-Lock) or the source code (E-Server).

AES encryption can be implemented in different strengths, 128, 192, and 256-bit strengths, ranging from strong to unbreakable. There is trade-off in speed as the strength increases, but since the information between the E-Lock and E-Server is at most 10 bytes, the 256-bit key strength was used simply because it is very strong.

If an attacker accesses the Database, all the information including user id and transaction pin codes are visible. The most valuable bit of information is the user id number, which can be used to access the system's services. To protect this information, the user id number will be encrypted upon registration and stored in cipher text in the database. This way, even if the database is compromised, the user id would be useless. MD5 encryption is a simple one-way encryption that cannot be decrypted.

Since software and network security has, and will continue to be a “cat-and-mouse” game, by following the modulation principle, these new encryption schemes can be implemented so long as the next iteration of the JCE or embedded device servers accommodate the newest and strongest security techniques.

Currently, many email services do not have any encryption for sending or receiving email. However, by using an “https” server rather than an “http”” one for all web-based interactions, conducted by the Mailer, intrudes can become deterred from packet sniffing since they will only see illegible characters. This https server should also be given an SSL certificate by a trusted third party such as VeriSign to prevent impersonation of the server.

It may be implemented such that the user receives an email to link to the https server. From there, he can log in read the message about his pin code (sender/receiver) or approval of a transaction (receiver). The same goes for registration (both) and initiating a transaction (sender).

Another technique would be to implement a maximum number of entries or even login attempts to prevent brute-force guessing which can be done through various programs. The pin codes should also be encrypted, similar to the username in case the Database is compromised. In this case when the E-Lock sends the pin to E-Server, the pin will be encrypted using a simple one-way encryption, the same kind that is stored in the database. Both PHP and Java support MD5. The EServer will then compare the encrypted strings to determine a match.

Although compiled Java can be reverse engineered using programs like Mocha, an application called Crema was created which scrambles the symbolic information in “.class” files so that they will become less vulnerable to de-compilation. In addition, hard coding pass code is a bad practice as passwords and phrases need to be refreshed or renewed periodically. Repetition can lead to a predictable pattern that can create an opportunity for intruders to identify important cipher text and be decoded by them. Some servers allow the root- or super-users to listen to the Java programs activity that can compromise the pass phrase secrecy as well.

One way to accommodate this is to use an asymmetric encryption scheme in which the E-Lock can send a passphrase to the EServer or vice versa for AES passphrase agreement. After which, the communication channel will be symmetrically AES encrypted. Unfortunately the embedded device servers currently available do not support dynamic passphrase encryption through Ethernet.

Another potential improvement to general security of the system may come from the implementation of a three-factor authentication model. Not only must the user fulfill this “something you have”, “something you know”, but they must also fulfill “something you are”. The last components deal with biometrics. Biometrics, or bioidentification, is the practice of measuring physical characteristics of a person to verify their identity.

One can add a module such as a retinal scan or fingerprint. Since you cannot change who you are when it comes to biometrics, the E-Server can access an ultra-secure and independent database to verify the user. This would simply require a subroutine or even a method call to access and retrieve the approval or disapproval. For example, a retinal eye scan occurs, then the E-Server sends the information to the independent biometric database. The name or a unique identifier (to prevent the John Smith syndrome where there are multiple users with identical names) would be retrieved. This identifier can be mapped, for example, to a university ID, assuming that the university also subscribes or administers the theoretical database. Thus making impersonation virtually impossible.

Overall, the asynchronous physical exchange system is quite secure and due to its modularity has the ability to become even more secure by adding biometrics, implementing various encryption schemas and closing the network. The security, on both the hardware and software sides, can be scaled from being nicely secure for everyday items or general public use or super secure for official government purposes or exchanging ultra-high priced items.

Alternative embodiments of the system will now be described.

Instead of creating one E-Lock box, a bank of boxes, or a row of them can be created, each assigned to the server and handled independently from each other. This will allow multiple transactions in a given space to occur. Another embodiment is a user options page where the user can change various options and settings such as email addresses card type with obvious security measures. In addition, on the options page, users can have a favorites listing that contains the email address and basic information of people he/she recently transacted with or favor. A history of transactions can also be implemented here.

The system may also include an email notification when the status of the transaction changes. For example, when a sender finishes putting the item in the box and locks it, the eServer can execute a mail subroutine that will notify the receiver that the item is ready to be received. With mobile technology, a text message can be sent to the sender and receiver about the status of their transaction and the box. In addition, with mobile computing, creating a transaction through SMS text messaging is very feasible. This of course requires a login and registration page as mentioned before.

In yet another embodiment, both the sender and receiver can be given a specific period in which to conduct their part of the transaction. If any party does not fulfill their part of the transaction, the box can go into a shut down mode, in which only the administrator or owner of the box will be able to access the box. Of course, a security measure can be implemented so that owner's access can only be allowed during a shutdown mode. For example, if the sender fails to place the intended item into the box then the system simple negates the transaction and validates or engages the next transaction. If the receiver fails to retrieve the items the box will lockdown and the only system owner can retrieve it.

Regarding the hardware and software of the system, since modulation is a key principle and the system will be able to accommodate any new technology as long as the modulation principle withstands. However, if necessary the modulation principle can be discarded.

As previously discussed, the system can continue to evolve and stay current with the next generation of network and hardware technology. Using modulation as a main driving force of system implementation, any sub-unit or module can be swapped out for a better one. For example, the ID card (e.g., something you have) can be swapped for a retina scan something you are or have. Thus, with Java's object oriented methodology, new encryption suites can easily be implemented without much programming with the use of JCE. Even if the AES encryption scheme were cracked, future encryption methods would ensure that the Asynchronous Physical Data Exchange System would be able to address this change.

Since newer and stronger alloys and material are always being developed, the physical vault (e.g., the E-Lock box) can be implemented by using any new suitable material or more conventional materials such as galvanized steel or titanium. In addition, the locking mechanism can be revised as long as it can be electronically controlled. The electronics of the E-Lock box can also be updated for components that are faster, more robust, and consume less power. However the logic should stay the same. An example would be to substitute the electronic components for a mini-ATX or a miniature yet full feature computer. This will enable more customization of the E-Lock and allow any programmable encryption or firewall to be implemented. This also raises the fragility of the E-Lock and the amount of security needed since the computers would be easier to access.

Applications of the system will now be described.

The E-Lock box, when placed in a common location such as a plaza or train station, could be used by anyone who is registered. It could also be exclusive, so that only members of a certain group such as employees, residents of a building, and members of a club can conduct transaction between themselves.

Commercially, by adding a vending module, the E-Lock box can be a storefront, or merchant allowing anyone to purchase or obtain the product given the correct amount of money. This scenario can work very well for classified ads where the buyer and seller can negotiate a price, then confirm purchase price through an E-Lock system with the vending module. The system flow is similar except that the receiver has not only shown proof of identity but also put the right change. A storefront can be added so someone can give them a ticket after the receiver has paid the person, similar to a can recycling center. This modification allows users and sense of anonymity and safety. Some people simply do not want a stranger to visit their house, or the job of selling something. The placement of the E-Lock box serves as a neutral ground between the groups location preference.

Another use of the system involves security deposit boxes similar to that of Swiss banks. As with currency, physical objects such as works of art, jewelry, antiques and relics can be exchanged or transferred between banks and persons. In this case, the transaction records and registration would be modified to protect anonymity. This may be accomplished by “linking” the ID numbers of the banks clients who are conducting the exchange. This would result in an E-Lock System using high security technology, the trademark of Swiss banking and safety deposits. The Electronic Lockbox System could be used to exchange priceless artifacts between clients, all in keeping with anonymity.

To detract from illegal transfer of goods via the E-Lock box, the system requires registration of all users. This registration requires an ID card and access to a valid email account. The system can be setup to require a credit card as a swipe card. In addition, cameras can also be placed around the physical location. Further, the system could generate an audit trail so that law enforcement authorities can follow it to the members of the transaction in question.

Instead of depending of commercial channels to obtain and purchase items, by facilitating transfer of physical goods according to an embodiment of the present invention, goods may be obtained cheaper, faster and more conveniently while recording and monitoring such a transaction to enhance the safety and public trust.

It is to be further understood that the present invention may be implemented in various forms of hardware, software, firmware, special purpose processors, or a combination thereof. In one embodiment, the present invention may be implemented in software as an application program tangibly embodied on a program storage device (e.g., magnetic floppy disk, RAM, CD ROM, DVD, ROM, and flash memory). The application program may be uploaded to, and executed by, a machine comprising any suitable architecture.

It is to be further understood that because some of the constituent system components and method steps depicted in the accompanying figures may be implemented in software, the actual connections between the system components (or the process steps) may differ depending on the manner in which the present invention is programmed. Given the teachings of the present invention provided herein, one of ordinary skill in the art will be able to contemplate these and similar implementations or configurations of the present invention.

It should also be understood that the above description is only representative of illustrative embodiments. For the convenience of the reader, the above description has focused on a representative sample of possible embodiments, a sample that is illustrative of the principles of the invention. The description has not attempted to exhaustively enumerate all possible variations. That alternative embodiments may not have been presented for a specific portion of the invention, or that further undescribed alternatives may be available for a portion, is not to be considered a disclaimer of those alternate embodiments. Other applications and embodiments can be implemented without departing from the spirit and scope of the present invention.

It is therefore intended, that the invention not be limited to the specifically described embodiments, because numerous permutations and combinations of the above and implementations involving non-inventive substitutions for the above can be created, but the invention is to be defined in accordance with the claims that follow. It can be appreciated that many of those undescribed embodiments are within the literal scope of the following claims, and that others are equivalent.

What is claimed is:

1. A network-based goods exchange system, comprising:
a mailer for receiving data from a first party and transmitting the data to a second party, wherein if the data received by the second party is confirmed, the mailer sends the first party a unique identifier and the second party a unique identifier;
a database for recording activity of the mailer;
a storage unit including a lock for securing an entrance to the storage unit, wherein the entrance to the storage unit is opened in response to the unique identifier sent to the first party, wherein when the entrance is opened the first party places a good inside the unit and closes the entrance, wherein when the entrance is closed the first party no longer has access to the storage unit; and
a server for receiving an indication that the first party has accessed the storage unit, wherein the server initiates a reminder that is sent to the second party, wherein after receiving the reminder, the second party opens the entrance, retrieves the good and closes the entrance, wherein when the entrance is closed the second party no longer has access to the storage unit.
